(19) United States
(12) Patent Application Publication
(10) Pub. No.: US 2018/0016481 A1
(43) Pub. Date: Jan. 18, 2018

(54) GRAPHITE PRESSURE-SENSITIVE ADHESIVE TAPE WITH RELEASE LINER

(71) Applicants: NITTO DENKO CORPORATION, Ibaraki-shi, Osaka (JP); NITTO, Inc., Lakewood, NJ (US)

(72) Inventors: Yoshio TERADA, Ibaraki-shi, Osaka (JP); Kyle Robert BARNES, Fremont, CA (US); Midori SEGAWA, Ibaraki-shi, Osaka (JP)

(73) Assignees: NITTO DENKO CORPORATION, Ibaraki-shi, Osaka (JP); NITTO, Inc., Lakewood, NJ (US)

(21) Appl. No.: 15/545,786

(22) PCT Filed: Dec. 27, 2016
(86) PCT No.: PCT/JP2016/088939

§ 371 Date: Jul. 24, 2017

Related U.S. Application Data
(60) Provisional application No. 62/437,853, filed on Dec. 22, 2016.
(60) Provisional application No. 62/275,300, filed on Jan. 6, 2016.

(51) Int. Cl. C09J 201/06; C09J 7/02; C09J 133/00; C09J 201/02

(52) U.S. Cl. CPC C09J 201/06; C09J 201/025; C01B 32/20; C09J 7/02; C09J 133/00

(57) ABSTRACT

Provided are a graphite pressure-sensitive adhesive tape that is suitable for improving thermal efficiency; and a graphite pressure-sensitive adhesive tape with a release liner, which contains the pressure-sensitive adhesive tape. This graphite pressure-sensitive adhesive tape with a release liner is provided with a graphite pressure-sensitive adhesive tape, which has a first pressure-sensitive adhesive layer and a graphite layer in this order, and a release liner that protects the surface of the first pressure-sensitive adhesive layer. The first pressure-sensitive adhesive layer has a single layer structure.

### TECHNICAL FIELD

The present invention relates to a graphite pressure-sensitive adhesive tape, and more specifically relates to a graphite pressure-sensitive adhesive tape with a release liner.

The present application claims priority on the basis of U.S. Provisional Patent Application No. 62/275,300, which was filed on 06 Jan. 2016, and U.S. Provisional Patent Application No. 62/437,853, which was filed on 22 Dec. 2016, and the entire contents of those applications are incorporated by reference in the present specification.

### BACKGROUND ART

Electronic devices generally include heat-generating elements such as electronic components and batteries. In order to dissipate heat generated by such a heat-generating element, attaching a graphite sheet to the heat-generating element is a known method. By transmitting heat from the heat-generating element to the graphite sheet, it is possible to efficiently dissipate heat in the in-plane direction of the graphite sheet. It is preferable to use a pressure-sensitive adhesive (PSA) to attach the graphite sheet to the heat-generating element. In general, PSA has characteristics to be in a soft solid (viscoelastic) state in a room temperature range and easily adhere to adherend with some pressure applied. For example, as a double-sided adhesive tape able to be used to attach a graphite sheet to an electronic component, Patent Literature 1 discloses a double-sided adhesive tape for a graphite sheet, which has an adhesive layer on both surfaces of a substrate.

### CITATION LIST

### Patent Literature

Patent Literature 1: Japanese Patent Application Publication No. 2015-124302

### SUMMARY OF INVENTION

### Technical Problem

In the case of a double-sided PSA tape having a PSA layer on both surfaces of a substrate, by adhering one PSA surface of the double-sided PSA tape to a graphite sheet, it is possible to configure a graphite PSA tape that exhibits PSA properties on one surface. By press-bonding a PSA surface of a graphite PSA tape having such a configuration to a heat-generating element, a graphite layer can be easily attached to the heat-generating element. Therefore, use of this graphite PSA tape can serve as an effective means for attaching a graphite layer to a heat-generating element more efficiently.

By adhering a conventional double-sided PSA tape 910 for graphite sheets, which has PSA layers 911 and 912 on both sides of a substrate (a carrier film) 913, to a graphite sheet 914, as shown in FIG. 1, it is possible to obtain a graphite PSA tape 920, which contains the PSA layer 911, the carrier film 913, the PSA layer 912 and the graphite sheet 914 in this order. A poly(ethylene terephthalate) (PET) film or the like can be used as the carrier film 913. However, a graphite PSA tape having this type of configuration is not satisfactory in terms of thermal efficiency.

One purpose of the disclosure according to this specification is to provide a graphite PSA tape that is suitable for improving thermal efficiency; and a graphite PSA tape with a release liner, which contains the PSA tape. Another purpose of the disclosure according to this specification is to provide a graphite PSA tape which exhibits good thermal efficiency and good workability; and a graphite PSA tape with a release liner, which contains the PSA tape.

### Solution to Problem

According to the embodiments described below, it is possible to overcome these and other disadvantages. However, the disclosure according to this specification is not required to overcome the disadvantages described above, and some embodiments of the disclosure may not overcome the problems described above.

According to an aspect of the disclosure according to this specification, there is provided a graphite PSA tape having improved thermal efficiency. According to an aspect of an exemplary embodiment, there is provided a graphite PSA tape that includes a PSA layer and a graphite layer in this order.

According to the disclosure in this specification, there is provided a graphite PSA tape having a first PSA layer and a graphite layer in this order. The first PSA layer has a single layer structure. Unlike the configuration of the graphite PSA tape shown in FIG. 1, a graphite PSA tape having this type of configuration does not have a carrier film between the graphite layer and the surface that adheres to an adherend (that is, the surface of the first PSA layer). Therefore, there is good transmission of heat from the adherend to which the graphite PSA tape is adhered to the graphite layer, and improved thermal efficiency can be achieved.

In addition, according to the disclosure in this specification, there is provided a graphite PSA tape with a release liner, which is provided with a graphite PSA tape, which has a first PSA layer and a graphite layer in this order, and a release liner that protects the surface of the first PSA layer. The first PSA layer has a single layer structure. In a graphite PSA tape with a release liner having this type of configuration, by adhering a surface of the first PSA layer (a PSA surface), which is exposed by peeling off the release liner, to an adherend, the graphite PSA tape can be easily attached to the adherend. In addition, because the graphite PSA tape that constitutes the graphite PSA tape with a release liner does not have a carrier film between the graphite layer and the surface that adheres to an adherend, improved thermal efficiency can be achieved.

In graphite PSA tapes with a release liner according to several aspects, the maximum value of the liner peeling force is approximately 0.5 N/50 mm or less when the liner peeling force is measured by peeling the release liner from the first PSA layer. Hereinafter, the expression “the maximum value of the liner peeling force” may, in some cases, be abbreviated to “liner peeling force”. A graphite PSA tape with a release liner having the liner peeling force mentioned above exhibits good workability when the release liner is peeled from the graphite PSA tape.

In several aspects, the thermal resistance in the thickness direction of the graphite PSA tape may be approximately 1.5 cm²·K/W or less. In this type of graphite PSA tape, heat can be efficiently transmitted from the adherend to which the graphite PSA tape is adhered to the graphite layer. Because the graphite PSA tape disclosed here does not contain a carrier film between the graphite layer and the surface that is adhered to the adherend, thermal resistance can be easily reduced.

In several aspects, the surface free energy γ of the release liner may be approximately 15 mJ/m² or less. The graphite PSA tape with a release liner disclosed here can be advantageously carried out using this type of release liner. The surface free energy γ of the release liner may be, for example, approximately 7 to 15 mJ/m².

In several aspects, the thickness of the first PSA layer may be approximately 5 μm or less. By limiting the thickness of the first PSA layer, it is possible to efficiently transmit heat from an adherend to the graphite layer. The thickness of the first PSA layer may be, for example, approximately 0.5 to 3 μm.

In several aspects, the first PSA layer may be a PSA layer consisting essentially of an acrylic PSA. A first PSA layer having this type of composition can adhere closely to an adherend surface, and by interposing such a first PSA layer between the graphite layer and the adherend surface, heat from the adherend can be efficiently transmitted to the graphite layer.

The thickness of the graphite layer may be, for example, approximately 15 μm or more. A graphite PSA tape with a release liner which has a graphite layer having such a thickness exhibits good workability when the release liner is peeled from the graphite PSA tape. In several aspects, the thickness of the graphite layer may be, for example, approximately 20 to 50 μm.

The thickness of the graphite PSA tape may be, for example, approximately 100 μm or less. A graphite PSA tape having a thickness that is limited in this way is suitable for reducing the weight or volume of a product that includes a member to which the graphite PSA tape is to be adhered. In several aspects, the thickness of the graphite PSA tape may be, for example, approximately 23 to 60 μm.

The graphite PSA tape may contain the first PSA layer, the graphite layer and a back surface layer in this order. A graphite PSA tape having this type of configuration can exhibit a variety of functions by utilizing the back surface layer that is arranged on the back surface side of the graphite layer, that is, the side of the graphite layer that is opposite the side on which the first PSA layer is disposed. In several aspects, the back surface layer may include at least a second PSA layer. The back surface layer may have a structure with a plurality of layers that includes the second PSA layer and a carrier film. The second PSA layer and/or the carrier film may be colored. At least one surface of the second PSA layer and/or the carrier film may be matted. The back surface layer may have the second PSA layer and a functional layer. The functional layer may be, for example, a layer that exhibits at least one function such as imparting aesthetic properties, electromagnetic wave shielding or electrical insulation.

In several aspects, the graphite PSA tape with a release liner disclosed in this specification is provided with a graphite PSA tape, which has a first PSA layer, a graphite layer and a second PSA layer in this order, and a release liner that protects the surface of the first PSA layer. Here, the first PSA layer has a single layer structure. According to a graphite PSA tape with a release liner having such a configuration, the graphite PSA tape can be easily attached to an adherend. In addition, because the graphite PSA tape that constitutes the graphite PSA tape with a release liner does not have a carrier film between the graphite layer and the surface that adheres to an adherend, improved thermal efficiency can be achieved.

Any graphite PSA tape with a release liner disclosed in this specification can be advantageously used in an aspect in which, for example, the release liner is peeled off and the graphite PSA tape is adhered to a heat-generating element of an electronic device.

According to this specification, there is provided a method for producing a graphite PSA tape with a release liner. Several aspects of this production method include a step of passing a graphite sheet through a PSA coater so as to coat a PSA on the graphite sheet. In addition, several aspects of this production method include a step of curing the PSA coated on the graphite sheet so as to form a first PSA layer, thereby forming the graphite PSA tape having the first PSA layer and the graphite sheet in this order. Furthermore, several aspects of this production method include a step of laminating a release liner on the graphite PSA tape, and then winding the obtained laminate. The method described above can be advantageously used to produce any graphite PSA tape with a release liner disclosed here.

Several other aspects of the method for producing a graphite PSA tape with a release liner provided by this specification include a step of passing a release liner through a PSA coater so as to coat a PSA on the release surface of the release liner. In addition, these aspects include a step of curing the PSA coated on the release liner and further include a step of laminating a graphite sheet on the release liner coated with the cured PSA, and then winding the obtained laminate. The method described above can be advantageously used to produce any graphite PSA tape with a release liner disclosed here.

According to this specification, there is provided a method for producing a graphite PSA tape having a first PSA layer having a single layer structure and a graphite layer in this order. Several aspects of this production method include a step of passing a graphite sheet through a PSA coater so as to coat (for example, spray-coat) a PSA on the graphite sheet. In addition, several aspects of this production method include a step of curing the PSA coated on the graphite sheet so as to form the first PSA layer. The method described above can be advantageously used to produce any graphite PSA tape disclosed here. By laminating a release liner on the obtained graphite PSA tape, it is possible to obtain a graphite PSA tape with a release liner.

### BRIEF DESCRIPTION OF DRAWINGS

FIG. 1 is a cross-sectional view that shows a graphite PSA tape obtained by adhering a conventional double-sided PSA tape for graphite sheets to a graphite sheet.

FIG. 2 is a cross-sectional view that shows a graphite PSA tape according to one embodiment.

FIG. 3 is a cross-sectional view that shows a graphite PSA tape with a release liner according to one embodiment.

FIG. 4 is a cross-sectional view that shows a graphite PSA tape according to another embodiment.

FIG. 5 is a cross-sectional view that shows a graphite PSA tape with a release liner according to another embodiment.

FIG. 6 is a cross-sectional view that shows a production target of a method for producing a graphite PSA tape with a release liner according to one embodiment.

FIG. 7 is an explanatory diagram that shows a method for producing a graphite PSA tape with a release liner according to one embodiment.

FIG. 8 is a frontal schematic view of an apparatus for evaluating thermal characteristics, which is used to measure thermal resistance values in the working examples.

FIG. 9 is a lateral schematic view of the apparatus for evaluating thermal characteristics shown in FIG. 8.

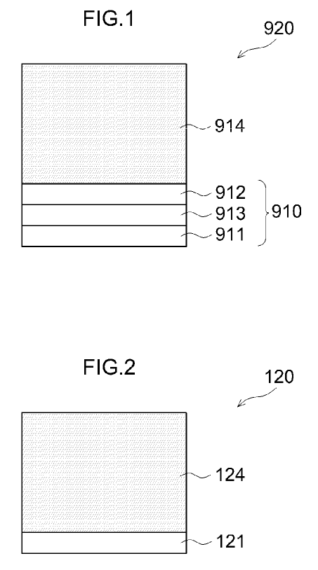

### DESCRIPTION OF EMBODIMENTS

Exemplary embodiments will now be explained with reference to the drawings, but these examples are intended to assist the understanding of the disclosure, and are not intended to limit the scope of the disclosure in any way.

Moreover, matters other than those explicitly mentioned in the present specification but which are essential for carrying out the invention are matters that a person skilled in the art could understand on the basis of disclosures relating to carrying out the invention disclosed in the present specification and common general technical knowledge at the time of filing. The present invention can be carried out on the basis of the matters disclosed in the present specification and common general technical knowledge in this technical field. In addition, in the drawings shown below, members/parts that perform the same action are denoted by the same symbols, and duplicate explanations will be omitted or simplified. In addition, the embodiments disclosed in the drawings are illustrated in order to clearly explain the present invention, and do not necessarily precisely show the size or scale of a product actually provided. In addition, the gist of a PSA tape in the present specification may encompass articles known as PSA sheets, PSA labels, PSA films, and the like. The graphite PSA tape and graphite PSA tape with a release liner disclosed here may be in the form of a roll or in the form of a sheet. Alternatively, the graphite PSA tape and graphite PSA tape with a release liner disclosed here may be processed into a variety of forms.

One embodiment of the graphite PSA tape disclosed here is shown in FIG. 2. This graphite PSA tape 120 has a first PSA layer 121 and a graphite layer 124 in this order. The first PSA layer 121 is coated on one side of the graphite layer 124.

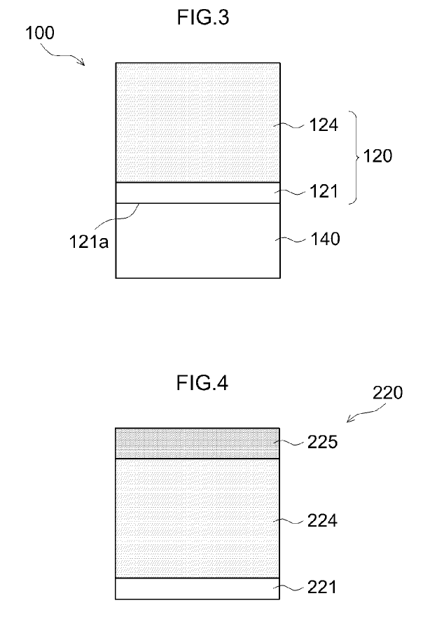

One embodiment of the graphite PSA tape with a release liner disclosed here is shown in FIG. 3. This graphite PSA tape 100 with a release liner has the graphite PSA tape 120 having the configuration shown in FIG. 2 and a release liner 140 that protects a surface (a PSA surface) 121a of the first PSA layer 121.

Another embodiment of the graphite PSA tape disclosed here is shown in FIG. 4. This graphite PSA tape 220 has a first PSA layer 221, a graphite layer 224 and a back surface layer 225 in this order. The first PSA layer 221 is coated on one surface of the graphite layer 224, and the back surface layer 225 is coated on the other surface (the opposite surface) of the graphite layer 224. In this embodiment, the back surface layer 225 is a decorative layer that is colored black. The back surface layer 225 may be, for example, a second PSA layer. The back surface layer 225 may have, for example, a structure with a plurality of layers that includes the second PSA layer.

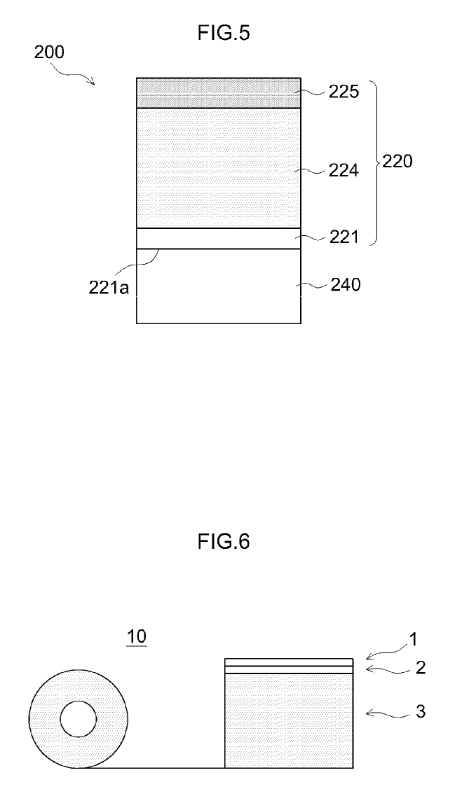

One embodiment of the graphite PSA tape with a release liner disclosed here is shown in FIG. 5.

This graphite PSA tape 200 with a release liner has the graphite PSA tape 220 having the configuration shown in FIG. 4 and a release liner 240 that protects the surface (the PSA surface) 221a of the first PSA layer 221.

Aspects of the graphite PSA tape and graphite PSA tape with a release liner will now be explained in greater detail.

<Graphite PSA Tape>

(Graphite Layer)

The graphite layer of the graphite PSA tape is not particularly limited, but a graphite sheet can be used. Graphite sheets exhibit high in-plane thermal conductivity and exhibit high anisotropy between in-plane thermal conductivity and thermal conductivity in the thickness direction, and can therefore effectively dissipate, in the in-plane direction, heat transmitted to the graphite sheet. The graphite PSA tape disclosed here can be obtained by coating or laminating a first PSA layer on one side of the graphite sheet. The graphite sheet may be a natural graphite sheet obtained by forming a sheet from a natural graphite powder, but may also be an artificial graphite sheet. Due to being thin and exhibiting high in-plane thermal conductivity, artificial graphite sheets can be advantageously used in several aspects.

An artificial graphite sheet can be obtained by, for example, heat treating a polymer film. Examples of the polymer film include films comprising polyimides, polyamides, polyoxadiazoles, polybenzothiazoles, polybenzobisthiazoles, polybenzoxazoles, polybenzobisoxazoles, poly(paraphenylene vinylene), polybenzimidazoles, polybenzobisimidazoles and polythiazoles. Of these, polyimide films are preferred. By using a polyimide film, a graphite sheet having good characteristics, such as thermal diffusivity, thermal conductivity and electrical conductivity, can be easily obtained. In addition, it is possible to easily obtain a graphite sheet which has high graphite crystallinity and excellent heat resistance and foldability and in which graphite is unlikely to fall from the surface.

Examples of commercially available graphite sheets include Graphinity manufactured by Kaneka Corporation and PGS sheets manufactured by Panasonic Corporation.

It is preferable for the graphite sheet to have an in-plane thermal conductivity of 200 W/m·K or more and a thermal conductivity in the thickness direction of 20 W/m·K or less. Graphite sheets having such high anisotropy between in-plane thermal conductivity and thermal conductivity in the thickness direction exhibit excellent in-plane thermal diffusivity. The arithmetic mean surface roughness Ra of a surface (for example, the front surface) of the graphite sheet may be, for example, 0.005 to 5 μm.

The thickness of the graphite layer can be suitably selected according to the purpose. The thickness of the graphite layer may be, for example, approximately 4 μm or more, and may be 5 μm or more. A graphite layer thickness of approximately 10 μm or more is generally suitable, and the graphite layer thickness may be 15 μm or more, or 20 μm or more. If the thickness of the graphite layer increases, durability and handleability are improved, and workability can be improved when the release liner is peeled from the graphite PSA tape. In several aspects, the thickness of the graphite layer may be approximately 30 μm or more. In addition, the thickness of the graphite layer may be, for example, approximately 100 μm or less, a thickness of 80 μm or less is generally suitable, and the thickness may be 60 μm or less, 50 μm or less, or 40 μm or less. Reducing the thickness of the graphite layer may contribute to making the graphite PSA tape thinner. In addition, a thin graphite layer is suitable for a graphite PSA tape having a configuration in which a plurality of graphite layers are laminated with or without a PSA layer interposed therebetween. In several aspects, the thickness of the graphite layer may be approximately 35 μm or less, or 30 μm or less.

(First PSA Layer)

The first PSA layer is disposed on one side of the graphite layer. One surface of the first PSA layer constitutes a PSA surface that is one surface of the graphite PSA tape. The graphite PSA tape disclosed here is typically used by applying the PSA surface to an adherend. One side of the graphite layer, that is, that surface of the graphite layer on which the first PSA layer is disposed, may be referred to as the front surface of the graphite layer. In addition, the other side of the graphite layer, that is, that surface of the graphite layer that is opposite the surface on which the first PSA layer is disposed, may be referred to as the back surface of the graphite layer. Similarly, one surface of the first PSA layer may be referred to as the front surface of the first PSA layer, and the other surface of the first PSA layer may be referred to as the back surface of the first PSA layer. The other surface of the first PSA layer is in contact with the front surface of the graphite layer. In addition, in the graphite PSA tape with a release liner disclosed here, one surface (the PSA surface) of the first PSA layer is in contact with a release surface (a surface having release properties) of a release liner, and is therefore protected by the release liner.

In several aspects, the first PSA layer has a single layer structure. A first PSA layer having a single layer structure is configured from a viscoelastic body having a composition that is uniform throughout the thickness of the layer. That is, a carrier film (or a backing or substrate) such as a resin film is not included between the front surface and back surface of the first PSA layer. In this type of first PSA layer that does not have a layer of a different material between the front surface and back surface of the PSA layer, heat transfer from the front surface to the back surface is not impaired by an interlayer interface. Therefore, it is possible to efficiently transmit heat from the front surface, which is adhered to the adherend, to the back surface, which is in contact with the graphite layer. Not interposing a carrier film between the front surface of the graphite layer and a PSA surface is advantageous in terms of improving the flexibility of the graphite PSA tape (and especially improving the flexibility at the PSA surface). By improving flexibility in this way, followability to an uneven surface (unevenness absorption properties) can be improved. In this way, the graphite layer and the adherend can be more tightly adhered via the first PSA layer, and heat transmission from the adherend to the graphite layer can be improved. In addition, because a carrier film is not included, the distance from the graphite layer to the PSA surface can be reduced. In this way, it is possible to reduce the distance from a heat source (a heat-generating element) to the graphite layer in a graphite PSA tape that is used by adhering the PSA surface to the heat source. In this way, thermal efficiency can be improved. Not interposing a carrier film can be advantageous in terms of improving processability. From the perspective of thermal efficiency, it is preferable for the first PSA layer to have a smooth surface.

The thickness of the first PSA layer can be suitably selected according to the purpose, and is not particularly limited. The thickness of the first PSA layer may be, for example, approximately 500 μm or less, and is preferably 200 μm or less or 100 μm or less. In several aspects, the thickness of the first PSA layer may be 50 μm or less, 20 μm or less, 10 μm or less, 8 μm or less, or 5 μm or less, from the perspective of improving thermal conductivity. The feature disclosed here can be advantageously carried out even in an aspect in which the thickness of the first PSA layer is 3 μm or less (for example, 2 μm or less or 1.5 μm or less). By reducing the thickness of a PSA layer (the first PSA layer) between the graphite layer and the heat source, better characteristics tend to be achieved. More specifically, if the thickness of the first PSA layer is reduced from 5 μm to 2 μm, the thickness of the bulk PSA between the heat source and the graphite layer is reduced by 60%, which improves thermal efficiency. Reducing the thickness of the first PSA layer can contribute to a simplification of the supply chain and an improvement in supply stability. In addition, the thickness of the first PSA layer may be, for example, approximately 0.1 μm or more, and a first PSA layer thickness of 0.5 μm or more is generally suitable. In several aspects, the thickness of the first PSA layer may be 1.0 μm or more or 1.5 μm or more from the perspective of improving close adhesion between the graphite layer and the adherend.

The type of PSA contained in the first PSA layer is not particularly limited. This PSA may be a PSA that contains, as a base polymer, one or two or more types selected from among a variety of polymers (PSA polymers) able to function as constituent components of PSAs, such as acrylic polymers, polyesters, urethane-based polymers, polyethers, rubber-based polymers, silicone-based polymers, polyamides and fluorine-based polymers. From perspectives such as PSA performance and cost, a PSA containing an acrylic polymer or a rubber-based polymer as a base polymer can be advantageously used. Of these, a PSA containing an acrylic polymer as a base polymer (an acrylic PSA) is preferred. An explanation will now be given mainly of a mode in which the first PSA layer is a PSA layer constituted from an acrylic PSA, that is, an acrylic PSA layer, but the first PSA layer in the feature disclosed here is not intended to be limited to an acrylic PSA layer.

Moreover, in this specification, the “base polymer” of the PSA means the primary component of a rubbery polymer contained in the PSA. This rubbery polymer means a polymer that exhibits rubber elasticity at temperatures close to room temperature. In addition, in this specification “primary component” means a component that is contained at a quantity of more than 50 wt. %, unless explicitly stated otherwise. In addition, “acrylic polymer” means a polymer that contains a monomer unit derived from a monomer having at least one (meth)acryloyl group per molecule as a monomer unit that constitutes the polymer. Hereinafter, a monomer having at least one (meth)acryloyl group per molecule is also referred to as an “acrylic monomer”. Therefore, in this specification, an acrylic polymer is defined as a polymer that contains a monomer unit derived from an acrylic monomer. A typical example of an acrylic polymer is an acrylic polymer in which the proportion of an acrylic monomer is more than 50 wt. % of the monomer components used to synthesize the acrylic polymer. In addition, “(meth)acryloyl” encompasses both acryloyl and methacryloyl. Similarly, “(meth)acrylate” encompasses both acrylate and methacrylate, and “(meth)acrylic” encompasses both acrylic and methacrylic.

In a preferred embodiment, the first PSA layer contains an acrylic PSA as a primary component. The first PSA layer may be a PSA layer consisting essentially of an acrylic PSA. Of these, an acrylic PSA containing acrylic polymer (A) as a primary component can be advantageously used. Acrylic polymer (A) contains, as a monomer unit, 50 wt. % or more of an alkyl (meth)acrylate having a straight chain or branched chain alkyl group having 1 to 20 carbon atoms (a C₁₋₂₀ alkyl (meth)acrylate). In the acrylic polymer (A), it is possible to use one C₁₋₂₀ alkyl (meth)acrylate in isolation or a combination of two or more types thereof. From perspectives such as the storage elastic modulus of the PSA, it is generally suitable for 50 wt. % or more of a C₁₋₁₄ alkyl (meth)acrylate (for example, a C₂₋₁₀ alkyl (meth)acrylate, and typically a C₄₋₈ alkyl (meth)acrylate) to be contained. From the perspective of PSA characteristics, it is preferable to incorporate 50 wt. % or more of a C₄₋₈ alkyl acrylate.

Examples of C₁₋₂₀ alkyl (meth)acrylates include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, pentyl (meth)acrylate, isopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, lauryl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate and eicosyl (meth)acrylate. It is possible to use one of these alkyl (meth)acrylates in isolation or a combination of two or more types thereof. Examples of preferred alkyl (meth)acrylates include n-butyl acrylate (BA) and 2-ethylhexyl acrylate (2EHA).

The proportion of the alkyl (meth)acrylate relative to the overall quantity of monomer components used to synthesize the acrylic polymer is preferably 70 wt. % or more, more preferably 85 wt. % or more, and further preferably 90 wt. % or more. The upper limit for the proportion of the alkyl (meth)acrylate is not particularly limited, but is generally preferably 99.5 wt. % or less (for example, 99 wt. % or less). Alternatively, the acrylic polymer may be obtained by polymerizing substantially only an alkyl (meth)acrylate. In addition, in cases where a C₄₋₈ alkyl acrylate is used as a monomer component, the proportion of the C₄₋₈ alkyl acrylate relative to alkyl (meth)acrylates contained in the monomer component is preferably 70 wt. % or more, more preferably 90 wt. % or more, and further preferably 95 wt. % or more (typically 99 to 100 wt. %). The feature disclosed here can be advantageously carried out in a mode in which 50 wt. % or more (for example, 60 wt. % or more, and typically 70 wt. % or more) of the overall quantity of monomer components is BA. In a preferred aspect, the monomer components as a whole may contain 2EHA at a proportion lower than that of BA.

Monomers other than those mentioned above (other monomers) may be copolymerized in the acrylic polymer. These other monomers may be used in order to adjust, for example, the glass transition temperature (Tg) or PSA performance (for example, peel performance) of the acrylic polymer. For example, examples of monomers able to improve the cohesive strength or heat resistance of a PSA include sulfonic acid group-containing monomers, phosphoric acid group-containing monomers, cyano group-containing monomers, vinyl esters and aromatic vinyl compounds. Preferred examples thereof include vinyl esters. Specific examples of vinyl esters include vinyl acetate (VAc), vinyl propionate and vinyl laurate. Of these, VAc is preferred.

In addition, examples of other monomers able to introduce functional groups capable of serving as crosslinking sites in the acrylic polymer or able to contribute to an improvement in adhesive strength include hydroxyl group (OH group)-containing monomers, carboxyl group-containing monomers, acid anhydride group-containing monomers, amide group-containing monomers, amino group-containing monomers, imide group-containing monomers, epoxy group-containing monomers, (meth)acryloyl morpholine and vinyl ethers.

In the feature disclosed here, preferred examples of acrylic polymers include acrylic polymers that are copolymerized with a carboxyl group-containing monomer as this other monomer. Examples of carboxyl group-containing monomers include acrylic acid (AA), methacrylic acid (MAA), carboxyethyl (meth)acrylate, carboxypentyl (meth)acrylate, itaconic acid, maleic acid, fumaric acid, crotonic acid and isocrotonic acid. Of these, AA and MAA are preferred.

Other preferred examples include acrylic polymers copolymerized with a hydroxyl group-containing monomer as this other monomer. Examples of hydroxyl group-containing monomers include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate and 4-hydroxybutyl (meth)acrylate; polypropylene glycol mono(meth)acrylate; and N-hydroxyethyl(meth)acrylamide. Of these, examples of preferred hydroxyl group-containing monomers include hydroxyalkyl (meth)acrylates in which the alkyl group is linear and has 2 to 4 carbon atoms.

It is possible to use one of these “other monomers” in isolation or a combination of two or more types thereof. The total content of these other monomers is preferably approximately 40 wt. % or less (typically 0.001 to 40 wt. %), and more preferably approximately 30 wt. % or less (typically 0.01 to 30 wt. %, for example 0.1 to 10 wt. %) of the overall quantity of monomer components.

In cases where a carboxyl group-containing monomer is used as this other monomer, a carboxyl group-containing monomer content of approximately 0.1 wt. % or more (for example, 0.2 wt. % or more, and typically 0.5 wt. % or more) and approximately 10 wt. % or less (for example, 8 wt. % or less, and typically 5 wt. % or less) of the overall quantity of monomer components is generally suitable. In cases where a hydroxyl group-containing monomer is used as this other monomer, a hydroxyl group-containing monomer content of approximately 0.001 wt. % or more (for example, 0.01 wt. % or more, and typically 0.02 wt. % or more) and approximately 10 wt. % or less (for example, 5 wt. % or less, and typically 2 wt. % or less) of the overall quantity of monomer components is generally suitable.

The copolymerization composition of the acrylic polymer should be designed so that the glass transition temperature (Tg) of the polymer is −15° C. or lower (typically −70° C. to −15° C.). The Tg value of the acrylic polymer is preferably −25° C. or lower (for example, −60° C. to −25° C.), and more preferably −40° C. or lower (for example, −60° C. to −40° C.). Setting the acrylic polymer Tg at a value equal to the abovementioned upper limit or lower is preferred from the perspective of improving close adhesion to an adherend.

The Tg value of the acrylic polymer can be adjusted by suitably altering the monomer composition (that is, the types and usage proportions of the monomers used to synthesize the polymer). Here, the Tg value of the acrylic polymer is a Tg value determined using the Fox equation on the basis of the composition of the monomer component used to synthesize the polymer. As shown below, the Fox equation is a relational expression between the Tg value of a copolymer and the glass transition temperatures Tgi of homopolymers obtained by homopolymerizing the monomers that constitute the copolymer.

1/Tg=Σ(Wi/Tgi)

Moreover, in the Fox equation, Tg denotes the glass transition temperature (units: K) of the copolymer, Wi denotes the weight proportion of a monomer i in the copolymer (the copolymerization proportion in terms of weight), and Tgi denotes the glass transition temperature (units: K) of the homopolymer of the monomer i.

Values disclosed in publicly known resources are used as glass transition temperatures of the homopolymers used to calculate the value of Tg. For example, the following values are used as glass transition temperatures of homopolymers of the monomers listed below.

2-ethylhexyl acrylate: −70° C.

Butyl acrylate: −55° C.

Vinyl acetate: 32° C.

Acrylic acid: 106° C.

Methacrylic acid: 228° C.

2-hydroxyethyl acrylate: −15° C.

4-hydroxybutyl acrylate: −40° C.

Numerical values disclosed in “Polymer Handbook” (third edition, John Wiley & Sons, Inc., 1989) are used as Tg values of homopolymers other than those listed above. In cases where values are not disclosed in the Polymer Handbook mentioned above, values obtained using the measurement method disclosed in Japanese Patent Application Publication No. 2007-51271 are used.

The acrylic polymer can be obtained by subjecting an alkyl (meth)acrylate ester to polymerization (for example, solution polymerization, emulsion polymerization, UV polymerization or bulk polymerization) together with a polymerization initiator. For example, solution polymerization can be advantageously used. Solvents (polymerization solvents) used in the solution polymerization can be selected as appropriate from among conventional publicly known organic solvents. For example, aromatic compounds (typically aromatic hydrocarbons) such as toluene, acetic acid esters such as ethyl acetate and aliphatic or alicyclic hydrocarbons such as hexane or cyclohexane can be advantageously used.

According to this solution polymerization, it is possible to obtain a polymerization reaction solution in a mode whereby an acrylic monomer is dissolved in an organic solvent. The PSA layer in the feature disclosed here can be formed from a solvent type PSA (an organic solvent solution of a PSA) that contains the polymerization reaction solution or an acrylic polymer solution obtained by subjecting the reaction solution to a suitable post-treatment. A solution obtained by adjusting the polymerization reaction solution to a suitable viscosity (concentration) if necessary can be used as the acrylic polymer solution. Alternatively, the PSA layer may be formed from a solvent type PSA that contains an acrylic polymer solution prepared by synthesizing an acrylic polymer using a polymerization method other than solution polymerization (for example, emulsion polymerization, photopolymerization or bulk polymerization) and then dissolving the acrylic polymer in an organic solvent. In addition to a solvent type PSA such as that mentioned above, the PSA used to form the PSA layer may be a PSA having a variety of forms, such as an emulsion type PSA, a hot melt type PSA, or an active energy ray-curable (for example, UV-curable) PSA. The PSA may be coated using a conventional publicly known coater such as a gravure coater, a die coater or a bar coater. Alternatively, the PSA may be coated by means of impregnation, a curtain coating method, a spray-coating method, or the like.

The weight average molecular weight (Mw) of the base polymer (preferably an acrylic polymer) is not particularly limited, and may, for example, fall within the range 10×10⁴ to 500×10⁴. From the perspective of PSA performance, the Mw value of the base polymer preferably falls within the range 10×10⁴ or more (for example, 20×10⁴ or more, and typically 35×10⁴ or more) and preferably falls within the range 150×10⁴ or less (for example, 75×10⁴ or less, and typically 65×10⁴ or less). Here, Mw is a value that is calculated in terms of standard polystyrene and is obtained by means of GPC (gel permeation chromatography). For example, an “HLC-8320GPC” (column: TSK gel GMH-H(S), manufactured by Tosoh Corporation) can be used as the GPC apparatus.

A variety of additives may, if necessary, be blended in the PSA. Non-limiting examples of such additives include tackifiers, crosslinking agents, auxiliary crosslinking agents, plasticizers, fillers, anti-aging agents, surfactants, coloring agents such as pigments and dyes, leveling agents, softening agents, antistatic agents, ultraviolet radiation absorbers, antioxidants and photostabilizers. The PSA may, or may not, have a variety of functions selected from among electrical conductivity, electromagnetic wave shielding properties and thermal conductivity. Additives used to impart one or two or more of these functions may be blended in the PSA.

Tackifier resins are not particularly limited, and it is possible to use a variety of tackifier resins, such as a rosin-based tackifier resin, a terpene-based tackifier resin, a hydrocarbon-based tackifier resin, an epoxy-based tackifier resin, a polyamide-based tackifier resin, an elastomer-based tackifier resin, a phenol-based tackifier resin, a ketone-based tackifier resin or an oil-soluble phenol resin. It is possible to use one such tackifier resin in isolation or a combination of two or more types thereof. In cases where an acrylic polymer is used as the base polymer, use of a rosin-based tackifier resin is preferred.

Examples of rosin-based tackifier resins include unmodified rosins (raw rosins) such as gum rosins, wood rosins and tall oil rosins; modified rosins obtained by modifying these unmodified rosins by means of hydrogenation, disproportionation, polymerization, or the like (hydrogenated rosins, disproportionated rosins, polymerized rosins, other chemically modified rosins; hereinafter the same); and other types of rosin derivative. Examples of these rosin derivatives include rosin esters such as compounds obtained by esterifying an unmodified rosin with an alcohol (that is, an esterified rosin) and compounds obtained by esterifying a modified rosin with an alcohol (that is, an esterified modified rosin); unsaturated fatty acid-modified rosins obtained by modifying an unmodified rosin or modified rosin with an unsaturated fatty acid; unsaturated fatty acid-modified rosin esters obtained by modifying a rosin ester with an unsaturated fatty acid; rosin alcohols obtained by reducing a carboxyl group in an unmodified rosin, a modified rosin, an unsaturated fatty acid-modified rosin or an unsaturated fatty acid-modified rosin ester; metal salts of rosins such as unmodified rosins, modified rosins and a variety of rosin derivatives (and especially rosin esters); and rosin phenol resins obtained by adding phenol to a rosin (an unmodified rosin, a modified rosin, a variety of rosin derivatives, or the like) with an acid catalyst and then carrying out thermal polymerization.

The softening point (softening temperature) of a tackifier resin to be used is not particularly limited. For example, a tackifier resin having a softening point of approximately 100° C. or higher (and preferably approximately 120° C. or higher) can be advantageously used. A rosin-based tackifier resin having such a softening point (for example, an esterified polymerized resin) can be advantageously used. The upper limit for the softening point of the tackifier resin is not particularly limited, and may be approximately 200° C. or lower (typically, approximately 180° C. or lower, for example, approximately 150° C. or lower). Here, the softening point of the tackifier resin is defined as a value measured using a softening point test method specified in JIS K5902 or JIS K2207 (a ring and ball method).

The usage quantity of the tackifier resin is not particularly limited, and may be specified as appropriate according to the target PS A performance (peel strength and the like). For example, it is preferable to use the tackifier at a proportion of approximately 10 parts by weight or more (more preferably 15 parts by weight or more, and further preferably 20 parts by weight or more) and preferably approximately 100 parts by weight or less (more preferably 80 parts by weight or less, and further preferably 60 parts by weight or less) relative to 100 parts by weight of the base polymer.

The type of crosslinking agent is not particularly limited, and may be selected as appropriate from among conventional publicly known crosslinking agents. Examples of such crosslinking agents include isocyanate-based crosslinking agents, epoxy-based crosslinking agents, oxazoline-based crosslinking agents, aziridine-based crosslinking agents, melamine-based crosslinking agents, peroxide-based crosslinking agents, urea-based crosslinking agents, metal alkoxide-based crosslinking agents, metal chelate-based crosslinking agents, metal salt-based crosslinking agents, carbodiimide-based crosslinking agents and amine-based crosslinking agents. It is possible to use one of these crosslinking agents in isolation or a combination of two or more types thereof. Of these, use of an isocyanate-based crosslinking agent and/or an epoxy-based crosslinking agent is preferred and use of an isocyanate-based crosslinking agent is particularly preferred from the perspective of improving cohesive strength. The usage quantity of the crosslinking agent is not particularly limited. For example, the usage quantity of the crosslinking agent may be selected within the range of approximately 10 parts by weight or less, preferably approximately 0.005 to 10 parts by weight, and more preferably approximately 0.01 to 5 parts by weight, relative to 100 parts by weight of the base polymer (preferably an acrylic polymer).

(90° Peel Strength)

It is preferable for the first PSA layer to have a 90° peel strength of approximately 1 N/20 mm or more. According to a graphite PSA tape provided with such a first PSA layer, the graphite layer is easily fixed to an adherend (for example, a heat-generating element). In several aspects, the 90° peel strength of the first PSA layer may be 3 N/20 mm or more or 5 N/20 mm or more. In addition, in several aspects, the 90° peel strength of the first PSA layer may be, for example, approximately 20 N/20 mm or less, 15 N/20 mm or less, or 10 N/20 mm or less from the perspective of improving liner release properties. The 90° peel strength of the first PSA layer is measured using the method disclosed in the working examples described later.

(Back Surface Layer)

The graphite PSA tape may further include a back surface layer that is provided on the other side of the graphite layer. This type of graphite PSA tape can be understood to be a graphite PSA tape having a first PSA layer, a graphite layer and a back surface layer in this order. The back surface layer may have a single layer structure or a multilayer structure having two or more layers.

The thickness of the back surface layer is not particularly limited, and may be, for example, approximately 10 mm or less. In several aspects, the thickness of the back surface layer may be 1 mm or less, 500 μm or less, 100 μm or less, 50 μm or less, 20 μm or less, 10 μm or less, or 5 μm or less. In addition, the thickness of the back surface layer may be, for example, approximately 0.1 μm or more, 1 μm or more, or 3 μm or more.

In several aspects, the back surface layer may contain a second PSA layer. The second PSA layer may be a layer that is coated or laminated on the back surface of the graphite layer. In such cases, one surface of the second PSA layer is in contact with the back surface of the graphite layer. The other surface of the second PSA layer may constitute a PSA surface that is the surface on the other side of the graphite PSA tape (the opposite side from the first PSA layer). A graphite PSA tape having such an aspect may be used as a graphite PSA tape that is adhesive on both sides. The graphite PSA tape disclosed here may have a back surface layer comprising only a second PSA layer.

The type of PSA contained in the second PSA layer is not particularly limited. This PSA may be a PSA that contains, as a base polymer, one or two or more types selected from among a variety of polymers (PSA polymers) able to function as constituent components of PSAs, such as acrylic polymers, polyesters, urethane-based polymers, polyethers, rubber-based polymers, silicone-based polymers, polyamides and fluorine-based polymers. The PSA contained in the second PSA layer may be selected as appropriate from among the same PSAs as the PSAs exemplified for the first PSA layer. The PSA contained in the second PSA layer may be the same as, or different from, the PSA contained in the first PSA layer.

The thickness of the second PSA layer can be suitably selected according to the purpose, and is not particularly limited. The thickness of the second PSA layer may be, for example, approximately 500 μm or less, is preferably 200 μm or less, and may be 100 μm or less, 50 μm or less, 30 μm or less, 20 μm or less, or 10 μm or less. In several aspects, the thickness of the second PSA layer may be 8 μm or less, 5 μm or less, 3 μm or less, 2 μm or less, or 1.5 μm or less. In addition, the thickness of the second PSA layer may be, for example, approximately 0.1 μm or more, 0.5 μm or more, 1 μm or more, 1.5 μm or more, or 3 μm or more.

The second PSA layer may be a layer comprising a PSA layer having a single layer structure. The graphite PSA tape disclosed here may have a back surface layer comprising only a second PSA layer having a single layer structure.

Alternatively, the second PSA layer may have a structure with a plurality of layers that includes a PSA layer and a carrier film (or a backing or substrate). The carrier film may be incorporated in the second PSA layer or coated or laminated on the other surface of the second PSA layer.

The second PSA layer may be a decorative (or cosmetic) PSA layer. Here, decorative means imparting aesthetic properties in order to adjust appearance or the like. The decorative PSA layer may be a layer that imparts aesthetic properties by means of the PSA per se, but may also be a layer that imparts aesthetic properties by having a layer that functions as a decorative layer (a carrier film or the like) inside the layer or on the back surface thereof. In several embodiments, the second PSA layer may be a black decorative PSA layer.

In cases where the second PSA layer, for example, is used as a decorative layer, the PSA layer or carrier film may be colored black, white, blue, red, green or another color. The surface of the second PSA layer or carrier film may, or may not, be matted.

In several aspects of a configuration in which the graphite PSA tape includes a back surface layer, the 60° gloss value of the back surface of the graphite PSA tape may be, for example, 15 or less. By reducing the gloss value in this way, it is possible to achieve a high quality appearance in which glossiness is suppressed. The 60° gloss value of the back surface may be 10 or less, 7 or less, 6 or less (typically 5.5 or less, for example less than 5.0) or 4.0 or less. The lower limit for the 60° gloss value of the back surface is not particularly limited, but may be 0.5 or more from a practical perspective, and is typically 1.0 or more (for example 1.5 or more). This back surface gloss value can be achieved by, for example, forming a matte layer on the back surface of the back surface layer (that is, the back surface of the graphite PSA tape) or by carrying out a matting treatment (surface treatment) such as embossing or sand blasting. The back surface 60° gloss value is measured at a measurement angle of 60° using a commercially available gloss meter (for example, a “High Gloss Gloss Checker IG-410” manufactured by Horiba, Ltd.).

In several aspects of a configuration in which the graphite PSA tape includes a back surface layer, the light transmittance of the back surface layer is not particularly limited. The light transmittance of the back surface layer may be, for example, 50% or less (typically 30% or less), 20% or less, 15% or less, or 10% or less. In several aspects, the light transmittance of the back surface layer may be less than 10% (for example, 7% or less, and typically 5% or less), 3% or less, approximately 2% or less, less than 1%, less than 0.5%, less than 0.1% or substantially 0%. Alternatively, the light transmittance may be 1% or more or 2% or more. The light transmittance is determined by orthogonally irradiating one surface of the PSA tape with light having a wavelength of 380 to 780 nm and measuring the intensity of light transmitted to the other surface of the PSA tape using a commercially available spectrophotometer. For example, a spectrophotometer manufactured by Hitachi, Ltd. (a “U4100 type spectrophotometer”) may be used as the spectrophotometer.

In several aspects, the back surface of the graphite PSA tape may have a lightness L* of 50 or less (for example, 40 or less, and typically 35 or less), as specified in the L*a*b* color system. The lightness L* is preferably 30 or less. A PSA tape having such a lightness may serve as a tape having a color tint that is suitable for a variety of applications in which a black color is desirable. The lower limit for the lightness L* is not particularly limited, but may be set to approximately 15 or more (for example, 20 or more) from the perspective of appearance or the like. The graphite PSA tape according to one aspect has a back surface 60° gloss value of 15 or less (preferably 10 or less, more preferably 7 or less, further preferably less than 5.0, for example 4.0 or less, and typically 0.5 or more, and preferably 1.0 or more, for example 1.5 or more), and has a lightness L* of 40 or less (for example, 15 to 35, and typically 20 to 30). A PSA tape having the back surface described above has reduced gloss and a black color having a sense of depth, and can therefore be used particularly advantageously in applications in which such aesthetic properties are required.

The chromaticity a* and chromaticity b*, as specified in the L*a*b* color system, of the back surface of the graphite PSA tape are not particularly limited. In several aspects, the chromaticity a* may fall within the range ±15 (for example, ±5, and typically ±2). In several aspects, the chromaticity b* may fall within the range ±15 (for example, ±10, and typically ±5). Moreover, in the present specification “within the range ±X” means within the range −X to +X.

Moreover, in the present specification, the L*a*b* color system is based on stipulations recommended by the International Commission on Illumination in 1976 or stipulations in JIS Z8729. Specifically, L*a*b* values are measured at a plurality of locations (for example, 5 points or more) on the back surface of the PSA tape using a color difference meter (product name “CR-400”, manufactured by Minolta), and the average of these values should be used.

A resin film can be advantageously used as the carrier film. Here, “resin film” typically means a substantially non-foamed resin film. That is, in this specification, the resin film may be one in which bubbles are substantially not present inside the resin film (a voidless resin film). Therefore, this resin film is distinct from a so-called foam film. In addition, this resin film is typically a substantially non-porous film, and is distinct from a so-called non-woven fabric or woven fabric. A carrier film that does not include a porous layer such as a foam, a non-woven fabric or a woven fabric, that is, a carrier film comprising a non-porous layer can be advantageously used.

Preferred examples of resin materials that constitute the resin film include polyolefin-based resins and polyester-based resins. Here, polyolefin-based resin means a resin that contains a polyolefin at a proportion of more than 50 wt. %. Similarly, polyester-based resin means a resin that contains a polyester at a proportion of more than 50 wt. %. Examples of polyolefin-based resin films include polyethylene (PE)-based resins, polypropylene (PP)-based resins, ethylene-propylene copolymers and ethylene-butene copolymers. Examples of polyester-based resins include poly(ethylene terephthalate) (PET)-based resins, poly(butylene terephthalate) (PBT)-based resins, poly(ethylene naphthalate) (PEN)-based resins and poly(butylene naphthalate)-based resins. Of these, polyester-based resins are preferred, and PET-based resins are particularly preferred from the perspectives of strength and processability.

If necessary, a variety of additives, such as fillers (inorganic fillers, organic fillers, and the like), anti-aging agents, antioxidants, ultraviolet radiation absorbers, anti-static agents, lubricants and plasticizers, may be blended in the resin film. The blending proportion of such additives is generally less than 30 wt. % (for example, less than 20 wt. %, and typically less than 10 wt. %).

A transparent resin film can be advantageously used as the carrier film. From perspectives such as strength, this type of resin film may be one that contains substantially no coloring agent. Here, a resin film that contains substantially no coloring agent means a resin film in which the content of a coloring agent is less than 1 wt. %, and preferably less than 0.1 wt. %. Alternatively, it is possible to use a resin film that is colored black, white (for example, milky white) or another color in order for the graphite PSA tape to exhibit desired aesthetic properties or optical characteristics (for example, light shielding properties). This coloration can be achieved by, for example, blending a publicly known organic or inorganic coloring agent (a pigment, a dye, or the like) in a material that constitutes the resin film layer. A resin film that is colored black may serve as a black layer. In order to adjust the aesthetic properties or optical characteristics of the graphite PSA tape, a colored layer obtained by coating, printing, or the like, may be provided on one or other surface of the carrier film.

The resin film disclosed here may have a single layer structure or a multilayer structure having two or more layers. From the perspective of shape stability, it is preferable for the resin film to have a single layer structure. The method for producing the resin film is not particularly limited, and a conventional publicly known method should be used as appropriate. For example, a conventional publicly known film formation method, such as extrusion molding, inflation molding, T-die cast molding or calender roll molding, can be used as appropriate.

The surface of the resin film may be subjected to a conventional publicly known surface treatment, such as corona discharge treatment, plasma treatment, ultraviolet irradiation treatment, acid treatment, alkali treatment or primer coating (formation of a primer layer). This type of surface treatment may be a treatment used to improve close adhesion between the resin film and a PSA layer or close adhesion between the resin film and a layer adjacent thereto (for example, a matte layer or colored layer). Moreover, the feature disclosed here can be advantageously carried out in a mode in which a primer layer is not formed between the resin film and a PSA layer and/or between the resin film and an adjacent layer and in which the resin film and a PSA layer are in direct contact with each other and/or the resin film and an adjacent layer are in direct contact with each other. A graphite PSA tape having this type of configuration may be thinner.

The thickness of the carrier film is not particularly limited. From perspectives such as flexibility of the graphite PSA tape, it is generally suitable for the thickness of the carrier film to be approximately 200 μm or less (for example, 100 μm or less, and typically 50 μm or less). In several aspects, the thickness of the carrier film may be, for example, 30 μm or less, 20 μm or less, 12 μm or less, 9 μm or less, or 5 μm or less. From perspectives such as reducing size and weight, the thickness of the carrier film may be, for example, 3 μm or less or 2 μm or less. From perspectives such as handling properties and processability, the thickness of the carrier film is preferably approximately 0.5 μm or more (for example, 1 μm or more), and may be more than 30 μm (for example, 35 μm or more).

In several aspects, the back surface layer may include a functional layer that exhibits one or two or more functions selected from among imparting aesthetic properties, electromagnetic wave shielding, electrical insulation, adjusting optical characteristics, protection, strengthening, imparting durability and imparting chemical resistance. This type of functional layer may be the second PSA layer or carrier film described above. In addition, the back surface layer may include this type of functional layer in addition to the second PSA layer and/or carrier film. The number of functional layers included in the back surface layer may be one or two or more.

The thickness of the graphite PSA tape disclosed here can be suitably selected according to the purpose. The thickness of the graphite PSA tape may be, for example, approximately 5 μm or more, is generally 10 μm or more, and may be 15 μm or more, 20 μm or more, 23 μm or more, or 25 μm or more. In several aspects, the thickness of the graphite PSA tape may be approximately 30 μm or more or 35 μm or more. In addition, the thickness of the graphite PSA tape may be, for example, 1000 μm or less, 100 μm or less, 75 μm or less, 60 μm or less, 50 μm or less, 40 μm or less, or less than 40 μm (for example, 39 μm or less). In several aspects, the thickness of the graphite PSA tape may be 35 μm or less, 30 μm or less, or less than 30 μm (for example, 29 μm or less). In addition, in several aspects of a graphite PSA tape having a back surface layer, the thickness of the graphite PSA tape may be, for example, approximately 12 mm or less, 5 mm or less, or 2 mm or less.

Moreover, the graphite PSA tape disclosed here may be a graphite PSA tape having a configuration in which a plurality of graphite layers and first PSA layers are layered from the perspectives of thermal efficiency and workability. This type of graphite PSA tape may have a configuration of, for example, graphite layer/first PSA layer/graphite layer/first PSA layer. In addition, the graphite PSA tape disclosed here may have a configuration having a first PSA layer on both sides of a graphite layer, such as first PSA layer/graphite layer/first PSA layer.

(Thermal Characteristics)

The thermal resistance value of the graphite PSA tape disclosed here is not particularly limited. From the perspective of increasing thermal efficiency, it is preferable for the thermal resistance value in the thickness direction of the graphite PSA tape to be approximately 1.5 cm²·K/W or less (as measured using a stationary heat flow method). A graphite PSA tape having such thermal characteristics exhibits good thermal conductivity and can advantageously contribute to dissipation of heat generated by an adherend to which the PSA tape is adhered. Therefore, a graphite PSA tape having such thermal characteristics can be advantageously used in, for example, an aspect in which the graphite PSA tape is adhered to a heat-generating element (a battery or the like) contained a portable electronic device or other type of electronic device.

In several aspects, the thermal resistance value of the graphite PSA tape may be, for example, approximately 1.4 cm²·K/W or less, approximately 1.3 cm²·K/W or less, or approximately 1.2 cm²·K/W or less from the perspective of further increasing thermal efficiency. The lower limit for the thermal resistance value of the graphite PSA tape is not particularly limited, but is typically approximately 0.1 cm²·K/W or more, and may be approximately 0.3 cm²·K/W or more. In several aspects, the thermal resistance value of the graphite PSA tape may be approximately 0.5 cm²·K/W or more or approximately 0.7 cm²·K/W or more from practical perspectives such as ease of production and workability.

The thermal conductivity of the graphite PSA tape is not particularly limited. From the perspective of increasing thermal efficiency, a graphite PSA tape having a thermal conductivity in the thickness direction (as measured using a stationary heat flow method) of more than 0.1 W/m·K is preferred. From the perspective of further increasing thermal efficiency, the thermal conductivity of the graphite PSA tape is preferably more than 0.2 W/m·K, and more preferably more than 0.3 W/m·K. In several aspects, the thermal conductivity of the graphite PSA tape may be 0.32 W/m·K or more or 0.35 W/m·K or more. The upper limit for the thermal conductivity of the graphite PSA tape is not particularly limited, but may be, for example, approximately 1.0 W/m·K or less or approximately 0.8 W/m·K or less from perspectives such as ease of production.

The thermal resistance value and thermal conductivity of the PSA tape may be evaluated using, for example, the methods disclosed in the examples described below (stationary heat flow methods).

<Release Liner>

A liner in which the surface opposite the first PSA layer is the release surface can be used as the release liner. For example, it is possible to use a release liner that has been subjected to a release treatment on the surface of a liner substrate, such as a resin film or paper, or a release liner provided with a liner substrate in which at least a surface of the substrate comprises a lowly adhesive material. Examples of such lowly adhesive materials include olefin-based resins (for example, PE, PP, ethylene-propylene copolymers and PE/PP mixtures), fluorine-based polymers (for example, polytetrafluoroethylene and poly(vinylidene fluoride) and silicone rubbers. A liner substrate provided with a surface comprising this type of lowly adhesive material can be used as the release liner without being subjected to a release treatment. Alternatively, it is possible to carry out a further release treatment on the surface of a liner substrate provided with a surface comprising this type of lowly adhesive material.

In several aspects, a release liner in which the surface of the liner substrate has been subjected to a release treatment can be advantageously used from the perspective of obtaining good liner release properties. This release treatment can be a treatment that forms a release treatment layer by means of a conventional method using a publicly known or commonly used release treatment agent (for example, a silicone-based, fluorine-based or long chain alkyl-based release treatment agent). For example, a release surface obtained by subjecting the PE resin surface of a high quality paper on which a PE resin is laminated or the surface of a polyester-based liner substrate to a release treatment using a silicone-based release treatment agent can be advantageously used.

The material of the liner substrate is not particularly limited. For example, it is possible to use a single layer body formed from a plastic, a paper, a variety of fibers, or the like (for example, a plastic film), or a laminate. Moreover, in this specification, “plastic film” typically means a non-porous film, and is distinct from a so-called non-woven fabric or woven fabric.

For example, a film comprising a polyolefin such as PE or PP; a polyester such as PET, PBT or PEN; a polyamide (nylon); cellulose (cellophane) or the like can be used as the plastic film. The plastic film may be unstretched or stretched (monoaxially or biaxially stretched).

For example, Japanese paper, Western paper, high quality paper, glassine paper, craft paper, full pack paper, crêpe paper, clay coated paper, top coated paper, synthetic paper, or the like, can be used as a paper substrate. The basis weight of the paper substrate is not particularly limited, and a basis weight of approximately 50 to 100 g/m² is generally suitable.

Examples of fiber-based substrates include woven fabrics and non-woven fabrics obtained by a variety of fibrous materials (natural fibers, semi synthetic fibers and synthetic fibers may be used; for example, cotton fibers, staple fibers, Manila hemp, pulp, rayon, acetate fibers, polyester fibers, poly(vinyl alcohol) fibers, polyamide fibers, polyolefin fibers, and the like) per se and blending such fibers.

Examples of substrates comprising other materials include rubber sheets comprising natural rubber, butyl rubber, or the like; foam sheets comprising foams such as polyurethane foams and polychloroprene rubber foams; metal foils such as aluminum foils and copper foils; and composites of these materials.

Examples of laminates include paper (for example, high quality paper) having a plastic film (for example, a PE resin layer) laminated on both surfaces.

Of these, examples of preferred liner substrates include polyester films, and of these, PET films are more preferred.

The silicone-based release treatment agent used to form the release treatment layer is not particularly limited, and can be suitably selected according to the purpose. Examples thereof include a thermosetting (typically a thermosetting addition type) silicone-based release treatment agent and an ionizing radiation-curable (typically UV-curable) silicone-based release treatment agent that is cured by application of heat or ionizing radiation (ultraviolet radiation, a radiation, β radiation, γ radiation, a neutron beam, an electron beam, or the like) after being coated. It is possible to use one of these in isolation, or a combination of two or more types thereof. From perspectives such as economy and simplicity of the apparatus required for application, a thermosetting (typically a thermosetting addition type) silicone-based release treatment agent can be advantageously used. In addition, these release treatment agents may be solventless agents that do not contain a solvent or solvent type agents which are dissolved or dispersed in an organic solvent. In addition, it is possible to blend an appropriate quantity of a solvent having a relatively low surface tension in a solventless release treatment agent so as to adjust the viscosity in order to facilitate application (typically coating). Furthermore, a catalyst such as a platinum-based catalyst may be added to a silicone-based release treatment agent such as a thermosetting silicone-based release treatment agent mentioned above in order to improve reactivity. From perspectives such as environmental health and reducing quantities of VOCs when forming the release treatment layer, it is preferable to use a solventless type release treatment agent which contains substantially no organic solvent and can be coated without further modification. A silicone-based release treatment agent such as that described above can be procured from, for example, Shin-Etsu Chemical Co., Ltd.

An example of a method for forming a release treatment layer on the release liner disclosed here is a method of forming a release treatment layer by coating a release treatment agent (for example, a silicone-based release treatment agent) on a liner substrate using a variety of coaters, and then drying. For example, a direct gravure coater, an offset gravure coater, a roll coater, a bar coater, a die coater, or the like, can be suitably selected as the coater. The drying conditions are not particularly limited, and drying conditions suitable for the type of release treatment agent being used can be suitably selected. In general, a drying temperature of approximately 80° C. to 150° C. is preferred.

The coated quantity of release treatment agent can be suitably selected according to the type of liner substrate, the type of release treatment agent, and the like being used. In several aspects, the coated quantity of release treatment agent may be, for example, 0.01 g/m² or more, 0.05 g/m² or more, 0.1 g/m² or more, or 0.5 g/m² or more in terms of solid content. In addition, it is generally suitable for the coated quantity of release treatment agent to be approximately 10 g/m² or less, and this coated quantity may be 7 g/m² or less, 5 g/m² or less, or 4 g/m² or less.

In cases where the release liner has a release treatment layer, the thickness of the release treatment layer is not particularly limited. From the perspective of achieving sufficient release properties, a release treatment layer thickness of, for example, approximately 0.03 μm or more is suitable, and this thickness is preferably approximately 0.05 μm or more. In addition, from perspectives such as film formability and cost, the thickness of the release treatment layer is, for example, 5 μm or less (and typically 3 μm or less).

The thickness of the release liner is not particularly limited. In several aspects, the thickness of the release liner may be, for example, 10 μm or more, 25 μm or more, or 35 μm or more from perspectives such as increasing the release workability of the release liner, and especially the adhering workability of the graphite PSA tape. In addition, from perspectives such as processability, the thickness of the release liner may be, for example, approximately 200 μm or less or 160 μm or less (for example, 100 μm or less).

In several aspects, a release liner in which the arithmetic mean roughness Ra of the release surface is less than 100 nm can be advantageously used, although this is not particularly limited. According to a release liner provided with a release surface having this type of high surface smoothness, surface smoothness of the first PSA layer protected by the release surface is maintained or improved, close adhesion to an adherend is improved, and heat from the adherend can be more efficiently transferred to the first PSA layer. Therefore, it is advantageous for the arithmetic mean roughness Ra of the release surface of the release liner to be low in order to improve adhesion of the graphite PSA tape to the adherend and improve heat dissipation properties. From these perspectives, the arithmetic mean roughness Ra of the release surface may be, for example, approximately 80 nm or less or approximately 60 nm or less. The lower limit for the arithmetic mean roughness Ra of the release surface is not particularly limited, but may be, for example, approximately 10 nm or more from a practical perspective.

Moreover, the arithmetic mean roughness Ra is the arithmetic mean roughness defined by the JIS surface roughness (B0601). An example of a method for measuring arithmetic mean roughness is a method that uses an NT8000 non-contact three-dimensional surface shape measuring apparatus manufactured by Veeco Instruments, Inc., New View 5032 manufactured by Zygo Corporation, a SPM-9500 atomic force microscope manufactured by Shimadzu Corporation, or the like.

(Surface Free Energy γ)

The surface free energy γ of the release surface is not particularly limited, and may be, for example, 20 mJ/m² or less. In several aspects, a release liner in which the surface free energy γ of the release surface is 15 mJ/m² or less can be advantageously used. A release liner having such a release surface can be one having a low liner peeling force. Therefore, a release liner having such a release surface can be advantageously used as a constituent element of the graphite PSA tape with a release liner. The surface free energy γ of the release surface may be 14 mJ/m² or less, 13 mJ/m² or less, or 12.5 mJ/m² or less. In addition, in several aspects, the surface free energy γ of the release surface may be 5 mJ/m² or more, 7 mJ/m² or more, or 10 mJ/m². A release surface having a surface free energy γ that is not too low can be advantageous from perspectives such as processability of the graphite PSA tape with a release liner and protection of the PSA surface.

The surface free energy γ is a value represented by the following expression: γ=γ^{d}+γ^{p}+γ^{h}. In the expression, γ^{d}, γ^{p} and γ^{h} denote the disperse component, polar component and hydrogen bond component, respectively, of the surface free energy γ. The surface free energy γ of the release surface is determined using the method disclosed in the working examples described below. The surface free energy γ of the release surface can be adjusted by altering, for example, the type of release treatment agent, the thickness of the release treatment layer, the conditions for forming the release treatment layer or the material of the liner substrate.

<Graphite PSA Tape with a Release Liner>

According to the disclosures in this specification, there is provided a graphite PSA tape with a release liner. According to several aspects, the graphite PSA tape with a release liner includes at least three layers, namely a first PSA layer having a single layer structure, a graphite layer and a release liner, and these layers are a laminate in which the release liner, the first PSA layer and the graphite layer are disposed in this order. A surface (PSA surface) of the first PSA layer is protected by the release liner.

(Liner Peeling Force)

In graphite PSA tapes with a release liner according to several aspects, the liner peeling force is approximately 0.5 N/50 mm or less, as measured when the release liner is peeled from the first PSA layer. In a graphite PSA tape with a release liner having a configuration in which a carrier film is not present between the PSA surface and the graphite layer, the load applied to the interface between the first PSA layer and the graphite layer tends to be greater when the release liner is peeled off compared to a configuration in which a carrier film is present. Therefore, the interface between the first PSA layer and the graphite layer is easily damaged when the release liner is peeled from the graphite PSA tape. If the structure of the interface between the first PSA layer and the graphite layer is corrupted, transmission of heat from the first PSA layer to the graphite layer is hindered and thermal efficiency deteriorates. In addition, if the smoothness of a surface (PSA surface) of the first PSA layer is damaged as a result of damage to this interface, close adhesion to an adherend deteriorates, which may be a cause of reduced thermal efficiency. Carefully carrying out a procedure for removing the release liner from the graphite PSA tape so as not to damage this interface can lead to a decrease in workability. According to a graphite PSA tape with a release liner in which the liner peeling force is limited to a prescribed value or lower, it is possible to easily peel off the release liner while suppressing damage to this interface.

The liner peeling force of the graphite PSA tape with a release liner disclosed here may be, for example, 0.45 N/50 mm or less or 0.4 N/50 mm or less. In several aspects, this liner peeling force may be 0.35 N/50 mm or less or 0.3 N/50 mm or less. In addition, because processability and PSA surface protection may deteriorate if the liner peeling force is too low, the liner peeling force may be approximately 0.01 N/50 mm or more, 0.05 N/50 mm or more, or 0.1 N/50 mm or more. In several aspects, the liner peeling force may be 0.15 N/50 mm or more or 0.20 N/50 mm or more.

The liner peeling force can be determined as the maximum value of the peel strength measured when carrying out a peeling test in which the release liner is peeled from the graphite PSA tape at a peeling angle of 180° and a rate of pulling of 300 mm/min in accordance with JIS Z0237 at a temperature of 23° C. and a relative humidity of 50%. In this peeling test, the peeling distance is 50 mm or more (preferably 70 mm or more, and typically 70 to 120 mm, for example approximately 100 mm) and this maximum value is determined for a region excluding approximately 20 mm from the end of the tape at which the peeling is started. More specifically, the liner peeling force is measured using the method disclosed in the working examples described below. The liner peeling force can be adjusted by adjusting, for example, the type of release liner (the type of release treatment agent used to form the release surface, the thickness of the release treatment layer, the conditions for forming the release treatment layer, the material of the liner substrate, and the like), the composition of the first PSA layer, the thickness of the first PSA layer, the surface condition of the PSA surface, or the like.

(Production Method)

According to this specification, there is provided a method for producing a graphite PSA tape and a graphite PSA tape with a release liner, which includes the graphite PSA tape. In several aspects, a resultant product (a product) obtained using this production method is a graphite PSA tape that includes a flexible graphite sheet as a carrier for a first PSA layer. This product may include a release liner that protects a PSA surface of the graphite PSA tape.

Several aspects of a graphite PSA tape with a release liner having the configuration shown schematically in FIG. 6 will now be exemplified, but are not intended to limit the method disclosed here. A graphite PSA tape 10 with a release liner, which is the production target, is a laminate having a three layer structure, which comprises a release liner 1, a first PSA layer 2 and a graphite sheet 3. The release liner 1 protects a surface of the first PSA layer 2. The first PSA layer 2 is a PSA that is coated or laminated on the front surface of the flexible graphite sheet 3. The first PSA layer 2 may, or may not, exhibit thermal conductivity or electrical conductivity. The graphite sheet 3 on which the PSA is coated or laminated may be naturally derived or synthetic.

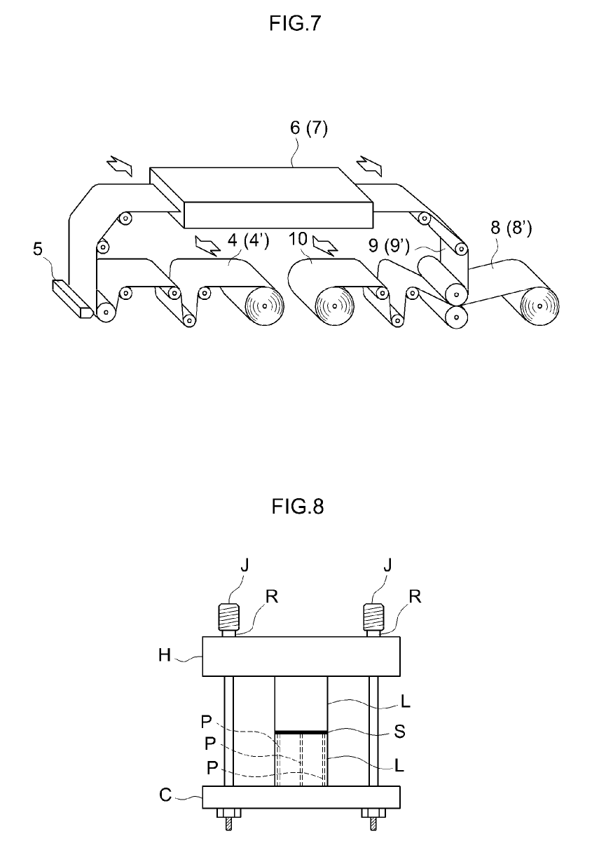

Several aspects relating to production of the graphite PSA tape 10 with a release liner shown in FIG. 6 will now be explained with reference to FIG. 7.

In a production method according to one aspect, a release liner 4 is unwound, passed through a PSA coater 5, coated with a solvent type PSA, and then cured in an oven 6. Alternatively, a UV-curable PSA is coated by the PSA coater 5 and then cured in a UV irradiation chamber 7. A long flexible graphite sheet 8 is unwound, laminated on a release liner (a release liner with PSA layer) 9 on which the completely cured PSA is coated, and then wound up as an end product (a graphite PSA tape with a release liner) 10.

In a production method according to another aspect, a long flexible graphite sheet 4′ is unwound, passed through the PSA coater 5, coated with a solvent type PSA, and then cured in the oven 6. Alternatively, a UV-curable PSA is coated by the PSA coater 5 and then cured in a UV irradiation chamber 7. A release liner 8′ is unwound, laminated on a graphite sheet (a graphite sheet with PSA layer) 9′ on which the completely cured PSA is coated, and then wound up as an end product (a graphite PSA tape with a release liner) 10. The PSA can be coated on the graphite sheet 4′ by means of, for example, spray-coating in the PSA coater 5. In order to spray-coat the PSA, it is possible to use an aerosol method or a forced air method.

<Intended Uses>

The graphite PSA tape disclosed here can be attached to a variety of adherends and can efficiently transmit heat from an adherend to the graphite layer. By utilizing this characteristic, the graphite PSA tape disclosed here can be advantageously used as a graphite PSA tape to be attached to a component of an electronic device (and especially a relatively small electronic device). The graphite PSA tape disclosed here is suitable for reducing thickness, and is therefore suitable for applications in which the graphite PSA tape is to be adhered to a component of a portable electronic device. The graphite PSA tape disclosed here can be advantageously used in a mode in which the graphite PSA tape is adhered to a heat-generating element (a battery, an IC chip, or the like) of this type of electronic device. In addition, the graphite PSA tape with a release liner disclosed here can be advantageously used in a mode in which the release liner is peeled off and the graphite PSA tape is adhered to an adherend such as those mentioned above.

Non-limiting examples of the portable electronic device mentioned here include cell phones, smart phones, tablet type computers, laptop computers, a variety of wearable devices (for example, wristwear devices that attach to a wrist, such as watches, modular devices that attach to a part of the body, such as clips and straps, eyewear such as eyeglasses (for one eye or both eyes; including head-mounted devices), clothing type devices such as accessories that attach to shirts, socks or hats, earwear type devices that attach to the ears, such as earphones), digital cameras, digital video cameras, acoustic devices (portable music players, IC recorders, and the like), computing devices (calculators and the like), portable gaming devices, electronic dictionaries, electronic notebooks, e-books, information devices for motor vehicles, portable radios, portable televisions, portable printers, portable scanners and portable modems. Moreover, in this specification, “portable” means not simply able to be carried, but having a level of portability enabling a device to be carried relatively easily by an individual (generally an adult).

Matters disclosed in this specification include those mentioned below.

(1) A graphite PSA having a PSA layer and a graphite layer in this order.

(2) A graphite PSA having a first PSA layer, a graphite layer and a second PSA layer in this order.

### EXAMPLES

Several working examples relating to the present invention will now be explained, but the present invention is in no way limited to these specific examples. Moreover, the term “parts” in the explanations below means parts by weight unless explicitly stated otherwise.

<Evaluation Methods>

(Thermal Characteristics)

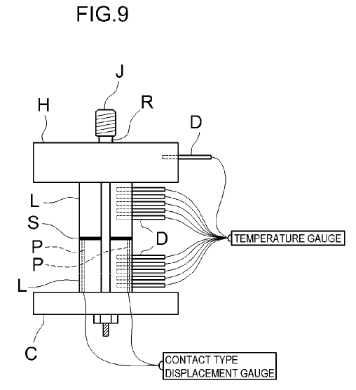

The thermal conductivity of the graphite PSA tape was evaluated using the apparatus for evaluating thermal characteristics shown in FIGS. 8 and 9. FIG. 8 is a frontal schematic view of an apparatus for evaluating thermal characteristics, and FIG. 9 is a lateral schematic view of the apparatus for evaluating thermal characteristics. Moreover, the release liner is removed when carrying out measurements.

Specifically, evaluation samples S, which were prepared by cutting graphite PSA tapes according to the examples into a square shape measuring 20 mm×20 mm, were held between a pair of aluminum (A5052, thermal conductivity: 140 W/m·K) blocks (also referred to as “rods” in some cases) L formed so as to be cubes measuring 20 mm on each side. Next, the pair of blocks L were arranged vertically so that the block L attached to the PSA surface of the evaluation sample S was facing upwards, and disposed between a heat-generating body (a heater block) H and a heat-dissipating body (a cooling base plate constituted so that cooling water is circulated inside the heat-dissipating body) C. Specifically, the heat-generating body H was disposed above the upper block L and the heat-dissipating body C was disposed below the lower block L.

Here, the pair of blocks L that hold the evaluation sample S are positioned between a pair of pressure adjustment screws J that pass through the heat-generating body H and the heat-dissipating body C. Moreover, a load cell R is disposed between a pressure adjustment screw J and the heat-generating body H, and the pressure is measured when the pressure adjustment screws J are tightened. This pressure was used as pressure applied to the evaluation sample S. Specifically, the pressure adjustment screws J in this test were tightened so that the pressure applied to the evaluation sample S was 25 N/cm² (250 kPa).

In addition, three probes P (diameter 1 mm) of a contact type displacement gauge were disposed so as to pass through the lower block L and the evaluation sample S from the heat-dissipating body C side. Here, the upper tips of the probes P were in contact with the lower surface of the upper block L, thereby enabling the gap between the upper and lower blocks L (the thickness of the PSA tape S) to be measured.

Temperature sensors D were attached to the heat-generating body H and the upper and lower blocks L. Specifically, a temperature sensor D was attached to one location of the heat-generating body H. In addition, temperature sensors D were attached at intervals of 5 mm in the vertical direction at five locations of each block L.

When carrying out measurements, the pressure adjustment screws J were first tightened so as to apply pressure to the evaluation sample S, the temperature of the heat-generating body H was set to 80° C., and cooling water having a temperature of 20° C. was circulated in the heat-dissipating body C.

Next, after the temperature of the heat-generating body H and the upper and lower blocks L had stabilized, the temperatures of the upper and lower blocks L were measured using the temperature sensors D, the heat flux passing through the evaluation sample S was calculated from the thermal conductivity values (W/m·K) of the upper and lower blocks L and the temperature gradient, and the temperatures at the interfaces between the upper and lower blocks L and the evaluation sample S were calculated. Using these values, the thermal conductivity values (W/m·K) and thermal resistance values (cm²·K/W) at this pressure were calculated using the following thermal conductivity equations (Fourier's law).

Q=−λgradT

R=L/X

Q: Heat flux per unit area

gradT: Temperature gradient

L: Thickness of evaluation sample S

λ: Thermal conductivity

R: Thermal resistance

(Surface Free Energy γ)

Using water, ethylene glycol and hexadecane as probe liquids, the surface free energy γ of the release surface of the release liner was determined from the contact angles of the probe liquids using the Kitazaki-Hata method (Journal of the Adhesion Society of Japan, Vol. 8, No. 3, 1972, pages 131-141). Contact angles were measured using a commercially available contact angle gauge.

(Maximum Value of Liner Peeling Force)

Evaluation samples were obtained by cutting the graphite PSA tapes with a release liner according to the examples to a size of 50 mm×150 mm. Using a tensile strength tester (product name “TCM-1kNB”, manufactured by MinebeaMitsumi Inc.), peel strength values for the evaluation samples were measured when the release liner was peeled from the PSA surface (the surface of the first PSA layer) of the graphite PSA tape at a temperature of 23° C., a relative humidity of 50%, a peeling angle of 180° and a rate of pulling of 300 mm/min. For the measurements, the length of evaluation sample peeled was 100 mm, and the maximum value of the peel strength measured for a region excluding approximately 20 mm from the end of the tape at which the peeling is started was recorded as the liner peeling force (N/50 mm). Moreover, measurements were carried out using three evaluation samples for each example (that is, N=3), and the liner peeling force was calculated by taking the arithmetic mean of the obtained values.

(Liner Release Properties)

The graphite PSA tapes with a release liner according to the examples were evaluated in terms of ease of separation between the graphite PSA tape and the release liner. Specifically, evaluation samples were prepared by cutting the graphite PSA tapes with a release liner according to the examples into squares measuring 30 mm×30 mm. When the graphite PSA tape was peeled from the release liner at one corner of the evaluation sample by the fingertips of the operator, it was observed visually whether or not damage (tearing of the graphite layer, peeling of the PSA layer, and the like) occurred at the interface between the graphite layer and the PSA layer. From these results, liner release properties were evaluated according to the following two grades.

G: Damage not observed (good liner release properties).

P: Damage observed (poor liner release properties).

(90° Peel Strength)

Single-sided PSA tapes were prepared in the same way as the graphite PSA tapes according to the examples, except that a poly(ethylene terephthalate) (PET) film having a thickness of 25 μm was used instead of the graphite sheet, and evaluation samples were obtained by cutting the single-sided PSA tapes to a width of 20 mm. The PSA surface of the evaluation sample was press-bonded to a stainless steel plate (a SUS304BA plate) as an adherend by passing a 2 kg roller back and forth once. After aging for 30 minutes at a temperature of 23° C. and a relative humidity of 50%, the sample was peeled from the adherend using a tensile strength tester (product name “Tensilon”, manufactured by Shimadzu Corporation) at a temperature of 23° C., a relative humidity of 50%, a rate of pulling of 300 mm/min and a peeling angle of 90°, and the peel strength (N/20 mm) at this point was measured.

### Example 1

70 parts of BA, 30 parts of 2EHA, 3 parts of AA, 0.05 parts of 4-hydroxybutyl acrylate (4HBA), and toluene as a polymerization solvent were placed in a reaction vessel, and oxygen in the system was removed by stirring for 2 hours while introducing nitrogen gas. A toluene solution of an acrylic polymer was obtained by adding 0.08 parts of 2,2′-azobisisobutyronitrile (AIBN) as a polymerization initiator and carrying out solution polymerization at 60° C. for 6 hours. The Mw value of this acrylic polymer was approximately 50×10⁴.

An acrylic PSA composition C1 was prepared by adding 30 parts of a polymerized rosin ester (product name “Pensel D-125”, softening point 120° C. to 130° C., manufactured by Arakawa Chemical Industries, Ltd.) as a tackifier resin and 2.0 parts of an isocyanate-based crosslinking agent (product name “Coronate L”, manufactured by Tosoh Corporation, solid content 75%) to 100 parts of the acrylic polymer contained in the toluene solution.

A PSA layer having a thickness of 3 μm was formed by coating acrylic PSA composition C1 on one surface of a commercially available graphite sheet (product name “Graphinity”, manufactured by Kaneka Corporation, thickness 25 μm), and then drying at 100° C. for 1 minute. In this way, a graphite PSA tape G1 having a configuration in which a single PSA layer (a first PSA layer) was adhered to one side of the graphite layer was obtained. In this graphite PSA tape G1, the thickness from the PSA surface that is one surface of the first PSA layer to the other surface of the graphite layer (that is, the back surface of the graphite PSA tape) was 28 μm.

A release liner R1 was prepared, which was a polyester film having a thickness of 38 μm and having a release surface subjected to a release treatment using a silicone-based release agent and in which the surface free energy γ of the release surface was 12.1 mJ/m². A graphite PSA tape with a release liner A1 was obtained by laminating the release surface of the release liner R1 to the PSA surface of the graphite PSA tape G1.

### Example 2

A release liner R2 was prepared, which was a polyester film having a thickness of 38 μm and having a release surface subjected to a release treatment using a silicone-based release agent and in which the surface free energy γ of the release surface was 12.7 mJ/m². A graphite PSA tape with a release liner A2 was obtained in the same way as in Example 1, except that release liner R2 was used instead of release liner R1.

### Example 3

A release liner R3 was prepared, which was a polyester film having a thickness of 38 μm and having a release surface subjected to a release treatment using a silicone-based release agent and in which the surface free energy γ of the release surface was 12.8 mJ/m². A graphite PSA tape with a release liner A3 was obtained in the same way as in Example 1, except that release liner R3 was used instead of release liner R1.

### Example 4

A PSA composition Cl was coated on the release surfaces of two release liners R3 and dried for 1 minute at 100° C. so as to form PSA layers having thicknesses of 1.5 μm. The PSA layers formed on the release surfaces of the two release liners R3 were adhered to the both surfaces of a PET film having a thickness of 2 μm (product name “Mylar”, manufactured by Teijin Dupont Films Japan Limited) used as a carrier film. In this way, a double-sided PSA tape with carrier film was formed so as to have a thickness of 5 μm and a three layer structure comprising PSA layer/carrier film/PSA layer. Next, the release liner R3 covering one PSA surface of the double-sided PSA tape was peeled off, and the exposed PSA surface was adhered to one surface of the graphite sheet. The release liner R3 covering the other PSA surface of the double-sided PSA tape remained on the PSA surface. In this way, a graphite PSA tape with a release liner A4 was obtained, which comprised the graphite PSA tape G2, in which a double-sided PSA tape with carrier having a three layer structure was adhered to one side of the graphite layer, and the release liner R3, which covered a PSA surface of the graphite PSA tape G2.

Results obtained by subjecting the examples described above to the evaluation methods described above are shown in Table 1.

TABLE 1

| | | Example 1 | Example 2 | Example 3 | Example 4 |
|---|---|---|---|---|---|
| Graphite PSA | Layer | Graphite layer | Graphite layer | Graphite layer | Graphite layer |
| tape | configuration | (25 μm) | (25 μm) | (25 μm) | (25 μm) |
| | (thickness) | PSA layer | PSA layer | PSA layer | PSA layer (1.5 μm) |
| | | (3 μm) | (3 μm) | (3 μm) | PET film (2 μm) |
| | | | | | PSA layer (1.5 μm) |
| Release liner | Type | R1 | R2 | R3 | R3 |

| | | | | |
|---|---|---|---|---|
| 90° peel strength (N/20 mm) | 6 | 6 | 6 | 6 |
| Thermal conductivity (W/m · K) | 0.4 | 0.4 | 0.4 | 0.3 |
| Thermal resistance (cm² · K/W) | 1.1 | 1.1 | 1.1 | 1.7 |
| Liner release properties | G | G | P | G |
| Maximum value of liner peeling | 0.28 | 0.38 | 0.52 | 0.52 |
| force (N/50 mm) | | | | |
| Surface free energy γ of release | 12.1 | 12.7 | 12.8 | 12.8 |
| surface (mJ/m²) | | | | |

As shown in Table 1, the graphite PSA tapes of Examples 1 to 3, which did not include a carrier film between the PSA surface and the graphite layer, had thermal resistance values that were at least 40% lower than that of the graphite PSA tape of Example 4, which included a carrier film, and therefore exhibited improved thermal efficiency. In addition, the graphite PSA tapes with a release liner of Examples 1 and 2, which had the lowest maximum value for liner peeling force, exhibited better liner release properties and superior adhering workability of the graphite PSA tape to an adherend compared to the graphite PSA tape with a release liner of Example 3.

Specific examples of the present invention have been explained in detail above, but these are merely examples, and do not limit the scope of the invention. The features described in the claims can include aspects obtained by variously modifying or altering the specific examples shown above.

### REFERENCE SIGNS LIST

1 Release liner
2 PSA layer
3 Graphite sheet
4 Release liner
4′ Graphite sheet
5 PSA coater
6 Oven
7 UV irradiation chamber
8 Graphite sheet
8′ Release liner
9 Release liner with PSA layer
9′ Graphite sheet with PSA layer
10 Graphite PSA tape with a release liner (end product)
100, 200 Graphite PSA tape with a release liner
120, 220 Graphite PSA tape
121, 221 First PSA layer
121a, 221a Surface (PSA surface)
124, 224 Graphite layer
140, 240 Release liner
225 Back surface layer

1. A graphite pressure-sensitive adhesive tape with a release liner, comprising:
a graphite pressure-sensitive adhesive tape having a first pressure-sensitive adhesive layer and a graphite layer in this order, and
a release liner that protects a surface of the first pressure-sensitive adhesive layer, wherein
the first pressure-sensitive adhesive layer has a single layer structure.

2. The graphite pressure-sensitive adhesive tape with a release liner according to claim 1, wherein a maximum value of liner peeling force is 0.5 N/50 mm or less when the liner peeling force is measured by peeling the release liner from the first pressure-sensitive adhesive layer.

3. The graphite pressure-sensitive adhesive tape with a release liner according to claim 1, wherein the graphite pressure-sensitive adhesive tape has a thermal resistance value in the thickness direction of 1.5 cm²·K/W or less.

4. The graphite pressure-sensitive adhesive tape with a release liner according to claim 1, wherein the surface free energy γ of the release liner is 15 mJ/m² or less.

5. The graphite pressure-sensitive adhesive tape with a release liner according to claim 1, wherein the thickness of the first pressure-sensitive adhesive layer is 5 μm or less.

6. The graphite pressure-sensitive adhesive tape with a release liner according to claim 1, wherein the first pressure-sensitive adhesive layer is a layer consisting essentially of an acrylic pressure-sensitive adhesive.

7. The graphite pressure-sensitive adhesive tape with a release liner according to claim 1, wherein the thickness of the graphite layer is 15 μm or more.

8. The graphite pressure-sensitive adhesive tape with a release liner according to claim 1, wherein the thickness of the graphite pressure-sensitive adhesive tape is 100 μm or less.

9. The graphite pressure-sensitive adhesive tape with a release liner according to claim 1, wherein
the graphite pressure-sensitive adhesive tape contains the first pressure-sensitive adhesive layer, the graphite layer and a back surface layer in this order, and
the back surface layer contains at least a second pressure-sensitive adhesive layer.

10. The graphite pressure-sensitive adhesive tape with a release liner according to claim 9, wherein the back surface layer has a structure with a plurality of layers that includes the second pressure-sensitive adhesive layer and a carrier film.

11. The graphite pressure-sensitive adhesive tape with a release liner according to claim 10, wherein at least one of the second pressure-sensitive adhesive layer and the carrier film is colored.

12. The graphite pressure-sensitive adhesive tape with a release liner according to claim 10, wherein at least one surface of at least one of the second pressure-sensitive adhesive layer and the carrier film is matted.

13. The graphite pressure-sensitive adhesive tape with a release liner according to claim 1, which is used by peeling off the release liner and adhering the graphite pressure-sensitive adhesive tape to a heat-generating element of an electronic device.

14. The graphite pressure-sensitive adhesive tape with a release liner according to claim 1, wherein
the first pressure-sensitive adhesive layer is a pressure-sensitive adhesive layer consisting essentially of an acrylic pressure-sensitive adhesive,
the thickness of the first pressure-sensitive adhesive layer is 1.5 to 5 μm,
the thickness of the graphite layer is 20 to 50 μm,
the thickness of the graphite pressure-sensitive adhesive tape is 23 to 60 μm,
the thermal resistance value in the thickness direction of the graphite pressure-sensitive adhesive tape is 1.5 cm²·K/W or less, and
the maximum value of the liner peeling force measured by peeling the release liner from the first pressure-sensitive adhesive layer is 0.5 N/50 mm or less.

15. A graphite pressure-sensitive adhesive tape with a release liner, comprising:
a graphite pressure-sensitive adhesive tape having a first pressure-sensitive adhesive layer, a graphite layer and a second pressure-sensitive adhesive layer in this order, and
a release liner that protects the first pressure-sensitive adhesive layer, wherein the first pressure-sensitive adhesive layer has a single layer structure.

16. A method for producing the graphite pressure-sensitive adhesive tape with a release liner according to claim 1,
the method comprising:
passing a graphite sheet through a pressure-sensitive adhesive coater so as to coat a pressure-sensitive adhesive on the graphite sheet;
curing the pressure-sensitive adhesive coated on the graphite sheet so as to form a first pressure-sensitive adhesive layer, thereby forming the graphite pressure-sensitive adhesive tape having the first pressure-sensitive adhesive layer and the graphite sheet in this order; and
laminating a release liner on the graphite pressure-sensitive adhesive tape, and then winding the obtained laminate.

17. A method for producing the graphite pressure-sensitive adhesive tape with a release liner according to claim 1,
the method comprising:
passing a release liner through a pressure-sensitive adhesive coater so as to coat a pressure-sensitive adhesive on a release surface of the release liner;
curing the pressure-sensitive adhesive coated on the release liner; and
laminating a graphite sheet on the release liner coated with the cured pressure-sensitive adhesive, and then winding the obtained laminate.

18. A method for producing a graphite pressure-sensitive adhesive tape having a first pressure-sensitive adhesive layer having a single layer structure and a graphite layer in this order,
the method comprising:
passing a graphite sheet through a pressure-sensitive adhesive coater so as to coat a pressure-sensitive adhesive on the graphite sheet; and
curing the pressure-sensitive adhesive coated on the graphite sheet so as to form the first pressure-sensitive adhesive layer.

19. The method for producing a graphite pressure-sensitive adhesive tape according to claim 18, wherein the pressure-sensitive adhesive coater spray-coats the pressure-sensitive adhesive onto the graphite sheet.
